(19) United States
(12) Patent Application Publication
(10) Pub. No.: US 2011/0124251 A1
(43) Pub. Date: May 26, 2011

(54) PANEL FOR RAISED FLOORS AND FLOORING CARRIED OUT WITH SUCH PANELS

(76) Inventor: Zecchi Cristiano, Certaldo (IT)

(21) Appl. No.: 12/625,948

(22) Filed: Nov. 25, 2009

(51) Int. Cl. D03D 9/00; B32B 18/00; D04H 13/00; B32B 17/02; C04B 35/00; C04B 33/00

(52) U.S. Cl. 442/1; 428/446; 442/327; 428/428; 501/1; 501/141

(57) ABSTRACT

The water-repellent panel (10) includes a support layer (4) in ceramic material, porcelain stoneware or ceramic granite

### BACKGROUND OF THE INVENTION

1. Field of the Invention

The present invention relates to improvements to raised floors and, in particular, to panels for raised floors.

2. Description of Related Art

Raised floors allow the laying of cables, ducts or similar beneath the walking surface. A raised floor usually comprises a supporting structure and a plurality of panels. The supporting structure supports the panels at a distance from an under-flooring. The panels have respective upper surfaces which form a walking surface.

Generally, the panels for raised floorings include a support layer made of wood or calcium sulphate, generically indicated as “support”, on which it is glued a thin finishing layer, indicated as “upper finishing”. The perimeter of the panel can have a protection border. The unit comprising support, upper finishing and possible border, if present, is indicated as “panel”.

The supports made of wood, calcium sulphate or other non water-repellent materials prevents the use of known panels for outdoor raised floors. The known panels are also exposed to risk of damages in the event of absorption of humidity by the support.

### SUMMARY OF THE INVENTION

The object of the present invention is to provide a panel for raised floors which will overcome the problems of the known panels.

According to the invention there is provided a water-repellent panel for raised floors, having a support of porcelain stoneware or ceramic granite (the terms porcelain stoneware, ceramic, ceramic granite or the indication of the same through their chemical description are to be considered equivalent and therefore part of the present invention) and it is devoid of wooden parts, calcium sulphate or other similar materials having water absorbent characteristics. According to some embodiments, the panel comprises a support layer of appropriate thickness and an upper finishing layer, advantageously applied by gluing. The finishing layer can be made of ceramic material. In this case the panel is finished and does not require the addition of a further finishing layer on the upper surface. In addition, the support, of suitable thickness, can be used to support a finishing layer to be installed in the construction site, such as carpeting, PVC or other materials.

Each panel can be made by a single body of ceramic (gross or finished) or by pairing a ceramic support of appropriate thickness and an upper finishing, Preferably, in this second instance a reinforcement layer can be added between the support and the finishing layer. The reinforcement layer can consist of a net, for example a net of polymeric material, or a layer of unwoven material, in synthetic fibres or other suitable material. The upper finishing can be made of ceramic material, for example the same ceramic material of which the support layer is made of. The total panel thickness can be chosen so as to withstand static or dynamic loads which this type of floors must be able to support.

The support layer and the upper finishing layer can the glued together with an appropriate glue, of such characteristics to fill in adequately the interstices between the two layers. In some embodiments the adhesive impregnates or encompasses the intermediate reinforcement layer, which is interposed between the support and the upper finishing layer. The reinforcement layer is for this scope opportunely permeable to the adhesive and/or equipped with openings and/or hatches and/or holes, for example constituted by the meshes of the net structure. The adhesive can be a bi-component polyurethane adhesive which will enable both a chemical and mechanical anchorage between the support and the finishing, that is an anchorage obtained thanks to the penetration of the adhesive in the micro porosities of the support and finishing.

The reinforcement layer is preferably made of a material suitable to create anchorage for the splinters that can be created in case of accidental breaking of the support and/or the finishing layer. This way, also thanks to the presence of the adhesive which encompasses the reinforcement layer and which is in contact with the lower surface of the finishing layer and the upper surface of the support, it is prevented that the splinters originating from an accidental rupture, for example a breaking of the support and/or of the finishing layer, shall be dispersed creating a danger due to their cutting edges.

In all the various configurations and embodiments the panel can be equipped with a perimeter border, and can present any suitable dimension.

### BRIEF DESCRIPTION OF THE DRAWINGS

The invention will be disclosed with reference to the annexed drawings, which shows a non-limiting example. In particular, the drawings show:

FIG. 1 a schematic lateral view of a first embodiment of a panel

FIG. 2 a schematic lateral view of a second embodiment of a panel

FIG. 3 an enlarged partial section of a support in the embodiment of FIG. 2

### DETAILED DESCRIPTION OF PREFERRED EMBODIMENTS

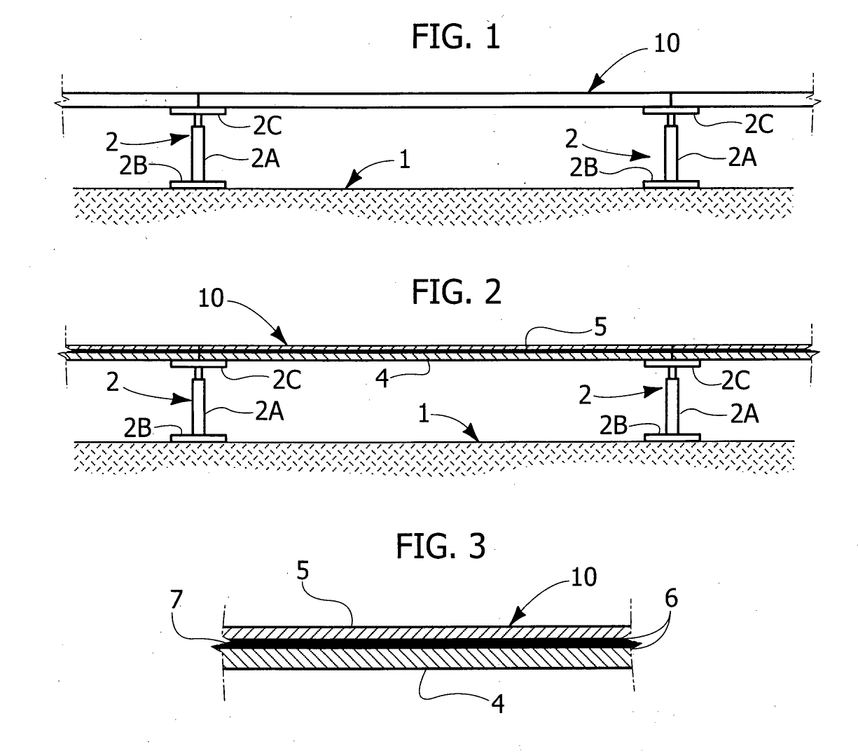

In the attached drawing and with an initial particular reference to FIGS. 1 and 2, the reference 1 indicates a surface over which has to be installed a raised floor and the reference 2 indicates the support structure of the raised floor. The support structure consists of a series of columns 2A, each having a foot 2B and a head 2C. The foot 2B is intended to lean on the surface 1 over which the raised floor is to be installed, while the head is usually placed in correspondence of the convergence of four corners of corresponding four panels of the raised floor, so that each panel is supported by four columns. Usually, the columns 2A are vertically adjustable.

In FIG. 1 the reference 10 indicates a panel which can constitute a support over which is then applied a surface finishing layer. The panel 10 is constituted by a single plate of a ceramic material, so-called porcelain stoneware or ceramic granite.

As shown in FIGS. 2 and 3, the panel 10 can be formed as a multi layer structure, so as to create directly with such multi layer structure a panel for raised floors with a surface finishing.

In the embodiment of FIG. 2 the panel 10 includes a support 4 formed by a single layer of ceramic material over which a finishing layer 5 is applied. The surface finishing 5 is also made of ceramic material.

As shown in particular in FIG. 3, a reinforcing flexible structure 7 is set between the support 4 and the finishing layer 5. The reinforcing flexible structure 7 is preferably formed by a net of polymeric material, such as polypropylene. In other embodiments the reinforcing flexible structure 7 may consist of a textile structure (usually a non-woven material) of glass fibres or other suitable fibrous material having high mechanic resistance, such as Kevlar. The reinforcing flexible structure 7 is surrounded by a layer of adhesive 6 which joins to each other the mutually facing surfaces of the support 4 and finishing layer 5.

The reinforcing flexible structure 7 incorporated in the adhesive layer 6 provides an improved resistance to breaking and in particular it forms a retaining structure for splinters that can be formed by breaking of the panel.

The panel 10 does not include wood or other non water-repellent material. According to the invention, a panel with a support and a finishing layer both made of ceramic material it is possible to make durable and steady raised floors with permanent characteristics, without the inconvenients that with time or in determinate conditions are incurred when using wood or non water-repellent materials for the support. Therefore, the panels according to the invention can be used for raised floors both for interior and exterior applications.

1. A water-repellent panel for raised floors, including a support layer made of ceramic material, porcelain stoneware or ceramic granite.

2. A panel according to claim 1, wherein the panel is devoid of wood, cement or calcium sulphate.

3. A panel according to claim 1, including a surface finishing layer glued to said support layer.

4. A panel according to claim 3, wherein said surface finishing layer is made of ceramic material.

5. A panel according to claim 4, wherein a reinforcement structure is arranged between said support layer and said surface finishing layer.

6. A panel according to claim 5, wherein the reinforcement structure consists of a net.

7. A panel according to claim 6, wherein said net is made of polymeric material.

8. A panel according claim 5, wherein said reinforcement structure consists of a layer of fibres.

9. A panel according claim 8, wherein said reinforcement structure consists of non-woven material.

10. A panel according to claim 8, wherein said reinforcement structure comprises glass fibres.

11. A panel for raised floors comprising:
a support layer of ceramic material;
a finishing layer of ceramic material;
a reinforcing structure made of polymeric material or non-woven fibres set between the support layer and the finishing layer;
a layer of glue encompassing the reinforcing structure and permanently connecting to each other mutually facing surfaces of the support layer and finishing layer.

12. A raised floor including a carrying structure supporting a plurality of panels, wherein each panel comprises a support layer made of ceramic material and a finishing layer of ceramic material glued to the support layer.

13. A raised floor according to claim 12, wherein each panel comprises a reinforcement structure arranged between said support layer and said surface finishing layer.

14. A raised floor according to claim 13, wherein the reinforcement structure consists of a net.

15. A raised floor according to claim 14, wherein said net is made of polymeric material.

16. A raised floor according to claim 13, wherein said reinforcement structure consists of a layer of fibres.

17. A raised floor according to claim 16, wherein said reinforcement structure consists of non-woven material.

18. A raised floor according to claim 17, wherein said reinforcement structure comprises glass fibres.
